(19) United States
(12) Patent Application Publication
(10) Pub. No.: US 2011/0029706 A1
(43) Pub. Date: Feb. 3, 2011

(54) ELECTRONIC DEVICE AND METHOD FOR CONTROLLING AN ELECTRONIC DEVICE

(75) Inventors: Marco Jan Gerrit Bekooij, 'S Hertogenbosch (NL); Andreas Hansson, Veldhoven (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/936,692

(22) PCT Filed: Apr. 9, 2009
(86) PCT No.: PCT/IB09/51504

§ 371 Date: Oct. 23, 2010

(30) Foreign Application Priority Data
Apr. 9, 2008 (EP) 08103451.4

(51) Int. Cl. G06F 13/40

(52) U.S. Cl. 710/110

(57) ABSTRACT

An electronic device is provided. The electronic device comprises at least one master network interface (MNI) with in a credit count unit (CC) for counting received credits and a first buffer unit (FIFO). The electronic device furthermore comprises at least one slave network interface (SNI) which comprises a threshold unit (TU) and at least one second buffer unit (FIFO). The electronic device furthermore comprises an interconnect (N) for coupling the at least one master network interface (MNI) and the at least one slave network interface (SNI). The slave network interface (SNI) is adapted to send a number of credits via the interconnect (N) to the master network interface (MNI) if the available amount of space or credits in the at least one second FIFO buffer (FIFO) reaches a threshold value stored in the threshold unit (TU). The slave network interface (SNI) is adapted to send the available credits via the interconnect (N) to the master network interface (MNI) if a predetermined time interval has lapsed or if an event from an external event generator is received even if the number of credits is below the threshold value stored in the threshold unit (TU).

### FIELD OF THE INVENTION

The present invention relates to an electronic device and to a method for controlling an electronic device.

### BACKGROUND OF THE INVENTION

Systems-on-chip SoC have become more and more popular in recent years. The components of the systems-on-chip SoC can be connected via an interconnect, e.g. like a network. During the communication in a system-on-chip SoC via an interconnect, care must be taken to avoid deadlocks.

In “Avoiding Message-Dependent Deadlock in Network-Based Systems on Chip” by Hansson et al., VLSI Design, Volume 2007, Hindawi Publishing Corporation, a link level flow control is described to prevent message-dependent deadlocks. FIG. 1 shows a block diagram of a part of a system-on-chip according to such prior art. Here, a master network interface MNI, a network N and a slave network interface SNI is depicted. The master network interface MNI comprises among others a credit count unit CC and a FIFO memory FIFO. The slave network interface SNI comprises a delta credit count unit DCC, a threshold unit TU and a FIFO memory FIFO. Data packets dp are transmitted from the master network interface MNI via the network N to the slave network interface SNI. Credit packets cp are transmitted from the slave network interface SNI to the master network interface MNI via the network. The master network interface MNI receives data for example from a IP module (not shown). The master network interface MNI furthermore receives requests req from the IP module and outputs acknowledgements ack to the IP module (this is performed by the FIFO memory FIFO). The credit count unit CC receives the credit packets cp from the slave network interface SNI via the network N. The slave network interface SNI receives the data packets dp from the master network interface SNI via the network N. The slave network interface SNI also receives requests from an IP module (not shown) coupled to the slave network interface SNI. The request req may indicate n-values. The slave network interface SNI may output an acknowledgement ack indicating n-values to the IP module. Furthermore, the slave network interface SNI may output data to the IP module.

The link level flow control is implemented by the slave network interface which sends packets with credits (i.e. credit packets cp) to the master network interface MNI if data is consumed by the slave network interface, i.e. if data has been forwarded to the IP module by the slave network interface SNI. The information in the credit packets cp indicate that space is available in the FIFO buffer in the slave network interface. The master network interface MNI is designed to only then send new packets to the slave network interface SNI if one or more credits have arrived in the credit packets from the slave network interface SNI. However, credit packets cp with credit information need to be sent from the slave network interface SNI to the master network interface MNI, i.e. via the network N. Therefore, a significant amount of network bandwidth of the network N may be required for the credit packets cp to implement the required link level flow control. The network bandwidth of the network N can be used up to 40% for transmitting the credit packets. Therefore, the slave network interface SNI can be adapted to only forward a credit packet cp if a minimum number of credits, i.e. space in the FIFO buffer, is available. Only then, the credit packet cp is sent from the slave network interface SNI to the master network interface MNI to indicate that a number of packets can be forwarded to the slave network interface SNI. In particular, a number can be stored and transmitted via the credit packet cp to indicate the amount of additional credits or amount of additional space in the FIFO buffer.

However, it should be noted that using this kind of threshold for transmitting the credits may cause deadlocks in the network. A deadlock can be detected at design time if the number of data words being consumed by a task does not depend on the input data values of the task. Here, it cannot be assured that a system is free from deadlocks. In other words, it cannot be guaranteed as data consuming tasks may request more data than available in the FIFOs of the slave network interfaces. To avoid this, all data of a task could be made available before a task can start. Accordingly, a deadlock can be detected at design time. Furthermore, it can be prevented that a processing unit cannot perform a task switch due to the fact that it has issued a data load operation resulting in a processor stall as the data is not present in the FIFO. If the number of data words requested by a task is smaller than the capacity of the FIFO of the slave network interface SNI, it can be realized that all the data of a task is available before the task can start. On the other hand, a FIFO in a network interface cannot be filled with the data if the credits in the network interface are below the available threshold and are therefore not returned to the master network interface MNI.

### SUMMARY OF THE INVENTION

It is an object of the invention to provide an electronic device with an improved deadlock capability.

This object is solved by an electronic device according to claim 1 and a method according to claim 6.

Therefore, an electronic device is provided. The electronic device comprises at least one master network interface with a credit count unit for counting received credits and a first buffer unit. The electronic device furthermore comprises at least one slave network interface which comprises a threshold unit and at least one second buffer unit. The electronic device furthermore comprises an interconnect for coupling the at least one master network interface and the at least one slave network interface. The slave network interface is adapted to send a number of credits via the interconnect to the master network interface if the available amount of space or credits in the at least one second FIFO buffer reaches a threshold value stored in the threshold unit. The slave network interface is adapted to send the available credits via the interconnect to the master network interface if a predetermined time interval has lapsed or if an event from an external event generator is received even if the number of credits is below the threshold value stored in the threshold unit.

Accordingly, by means of the timer unit, a deadlock in the communication due to the fact that first a specific number of credits must be available before the credits are forwarded to the master network interface can be avoided.

According to an aspect of the invention, the at least one timer unit is provided for each buffer unit in the slave network interface. Accordingly, a deadlock can be prevented for each of the buffer units.

According to a further aspect of the invention, the timer unit comprises at least one register for storing the predefined time intervals.

According to a further aspect of the invention the slave network interface comprises a delta credit count unit for determining the number of packets being outputted from the at least one second buffer unit and for forwarding this information to the threshold unit such that the available amount of credits is stored in the delta credit count unit.

According to an aspect of the invention the at least one slave network interface comprises a timer unit for counting to the predetermined time interval.

The invention also relates to a method for controlling an electronic device. The electronic device comprises at least one master network interface with a credit count unit for counting received credits and a first buffer unit, at least one slave network interface having a threshold unit and at least one second buffer unit and an interconnect for coupling the master network interface and the at least one slave network interface. A number of credits is sent from the slave network interface via the interconnect to the master network interface if an available amount of credits in the at least one second buffer unit reaches a threshold value. The available credits are sent from the slave network interface to the master network interface if a predetermined time interval has lapsed or if an event from an external event generator is received.

The invention relates to the idea that a timer is added in a slave network interface. Even if the credits are below the threshold of the threshold unit, all credits are returned in a packet after a predetermined time interval.

Further aspects of the invention are described in the dependent claims.

### BRIEF DESCRIPTION OF THE DRAWINGS

Advantages and embodiments of the invention are now described in more detail with reference to the Figures.

FIG. 1 shows a block diagram of a system-on-chip according to the prior art, and

FIG. 2 shows a block diagram of an electronic device according to a first embodiment.

### DETAILED DESCRIPTION OF EMBODIMENTS

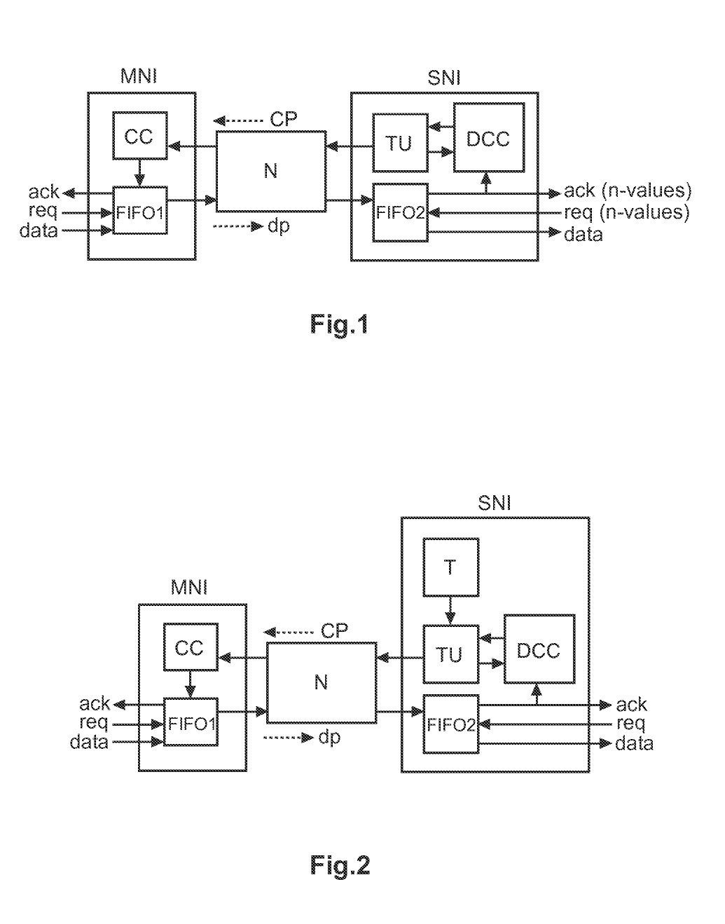

FIG. 2 shows a block diagram of an electronic device according to a first embodiment. The electronic device according to the first embodiment can be implemented as or can comprise a system-on-chip SoC. The system-on-chip SoC may comprise an interconnect N which can be implemented as a network N. A master network interface MNI and at least one slave network interface SNI are coupled to the interconnect N. The network interfaces may be used to couple IP modules to the interconnect. The IP modules can be a processing unit, a memory, dedicated processing units like video graphic units, etc. The network interfaces serve as an interface between the IP modules and the interconnect. Accordingly, the IP modules do not need to be re-designed as the network interfaces will take care of the interconnect-related communication protocol. The electronic device according to FIG. 2 basically corresponds to the electronic device according to FIG. 1. The slave network interface comprises a threshold unit TU, a delta credit count unit DCC and a FIFO buffer. If a number of packets has been forwarded from the FIFO memory in the slave network interface SNI to the IP module connected to the slave network interface SNI, the delta credit count unit DCC will determine this amount and will forward the information to the threshold unit TU. If the threshold of the threshold unit TU has been reached, the respective credit information is forwarded in the credit packets cp via the network N to the master network interface MNI. Then, the master network interface MNI can send a corresponding amount of data packets dp to the slave network interface SNI.

The timer unit T will start to count and after a predefined time interval it will initiate that all credits are sent via the credit packets cp to the master network interface MNI even if the credit count has not yet reached the threshold value in the threshold unit TU. Accordingly, a deadlock can be avoided. Alternatively or in addition, an event from an external event generator can be received to initiate that all credits are sent via the credit packets to the master network interface MNI.

According to a second embodiment which can be based on the first embodiment, one timer unit T can be provided in each network interface for all the FIFO buffers of the network interface. If the predefined time interval as stored in the timer unit has lapsed after the timer unit has been activated, all available credits in the FIFO buffers are returned to the master network interface MNI. Accordingly, deadlocks due to the threshold values can be avoided. It should be noted that the use of one timer unit T in a slave network interface SNI will make it difficult to differentiate the maximum release time for each FIFO buffer. Accordingly, the analysis of the minimum guaranteed throughput will be less accurate. Furthermore, more credit packets will be forwarded to the master network interface than actually required.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be constrained as limiting the scope of the claims.

1. Electronic device, comprising:
at least one master network interface having a credit count unit for counting received credits and a first buffer unit,
at least one slave network interface having a threshold unit and at least one second buffer unit, and
an interconnect for coupling the master network interface and the at least one slave network interface,
wherein the slave network interface is adapted to send a number of credits via the interconnect to the master network interface if an available amount of credits in the at least one second buffer unit reaches a threshold value stored in the threshold unit,
wherein the slave network interface is adapted to send the available credits via the interconnect to the master network interface if a predetermined time interval has lapsed or if an event from an external event generator is received, even if the number of credits is below the threshold value stored in the threshold unit.

2. Electronic device according to claim 1, wherein at least one timer unit is provided for each second buffer unit in the slave network interface.

3. Electronic device according to claim 2, wherein the timer unit comprises at least one register for storing the predefined time interval.

4. Electronic device according to claim 1, wherein the slave network interface comprises a delta credit count unit for determining a number of packets being outputted from the at least one second buffer unit and for forwarding this information to the threshold unit such that the available amount of credits is stored in the delta credit count unit.

5. Electronic device according to claim 1, wherein the at least one slave network interface comprises a timer unit for counting to the predetermined time interval.

6. Method for controlling an electronic device having at least one master network interface having a credit count unit for counting received credits and a first buffer unit, at least one slave network interface having a threshold unit and at least one second buffer unit, comprising the steps of:
coupling the master network interface and the at least one slave network interface,
sending a number of credits from the slave network interface to the master network interface if an available amount of credits in the at least one second buffer unit reaches a threshold value, and
sending the available credits from the slave network interface to the master network interface if a predetermined time interval has lapsed or if an external event from an external event generator is received even if the number of credits is below the threshold value.
